(19) United States
(12) Patent Application Publication
(10) Pub. No.: US 2008/0244327 A1
(43) Pub. Date: Oct. 2, 2008

(54) TRACE DEVICE FOR MONITORING ELECTRONIC DEVICE

(75) Inventors: Robert J. Coombes, Longmont, CO (US); Daniel G. Nylander, Longmont, CO (US); Robert Metz, Westminster, CO (US); Lace J. Herman, Firestone, CO (US)

Correspondence Address: HENSLEY KIM & HOLZER, LLC, 1660 LINCOLN STREET, SUITE 3000, DENVER, CO, 80264, US

(73) Assignee: SEAGATE TECHNOLOGY LLC, Scotts Valley, CA (US)

(21) Appl. No.: 11/692,790

(22) Filed: Mar. 28, 2007

(51) Int. Cl. G06F 11/00

(52) U.S. Cl. 714/45

(57) ABSTRACT

A trace device for monitoring and storing trace data of a device under test (DUT) is provided. The trace device is coupled in situ with the DUT when the DUT is in its operating environment (e.g., when the DUT is located within a rack, housing, or enclosure including the DUT). The trace device comprises a trace data buffer for storing trace data received from the DUT during operation.

### SUMMARY

Implementations described and claimed herein provide a trace device for monitoring and storing trace data of a device under test (DUT). The trace device is coupled in situ with the DUT when the DUT is in its operating environment (e.g., when the DUT is located within a rack, array structure, housing, or enclosure including the DUT). The trace device comprises a trace data buffer for storing trace data received from the DUT during operation.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTIONS OF THE DRAWINGS

FIG. 1 illustrates an exemplary representation of a trace device used to monitor a device under test (DUT) in situ within its operating environment.

FIGS. 2A-2C illustrate exemplary representations of a trace device.

FIG. 3 illustrates exemplary operations for setting up a test of a DUT in its operating environment.

FIG. 4 illustrates exemplary operations for downloading trace data from a trace device.

FIG. 5 illustrates a trace device in form factor with a DUT that complies with the DUT in at least two dimensions.

### DETAILED DESCRIPTIONS

Electronic devices often include a processor that executes code. When errors arise during operation of such an electronic device, trace data is often captured and used to determine the source of the error. Typically, the electronic device is removed from its operating environment and taken to a laboratory for analysis. The electronic device is connected to a logic analyzer through a spy board in the laboratory. The spy board receives trace signals from the electronic device and forwards the trace signals to the logic analyzer. The logic analyzer is typically not only a large instrument but is also highly sensitive to environmental conditions and must be operated in a controlled environment (e.g., a cooled laboratory).

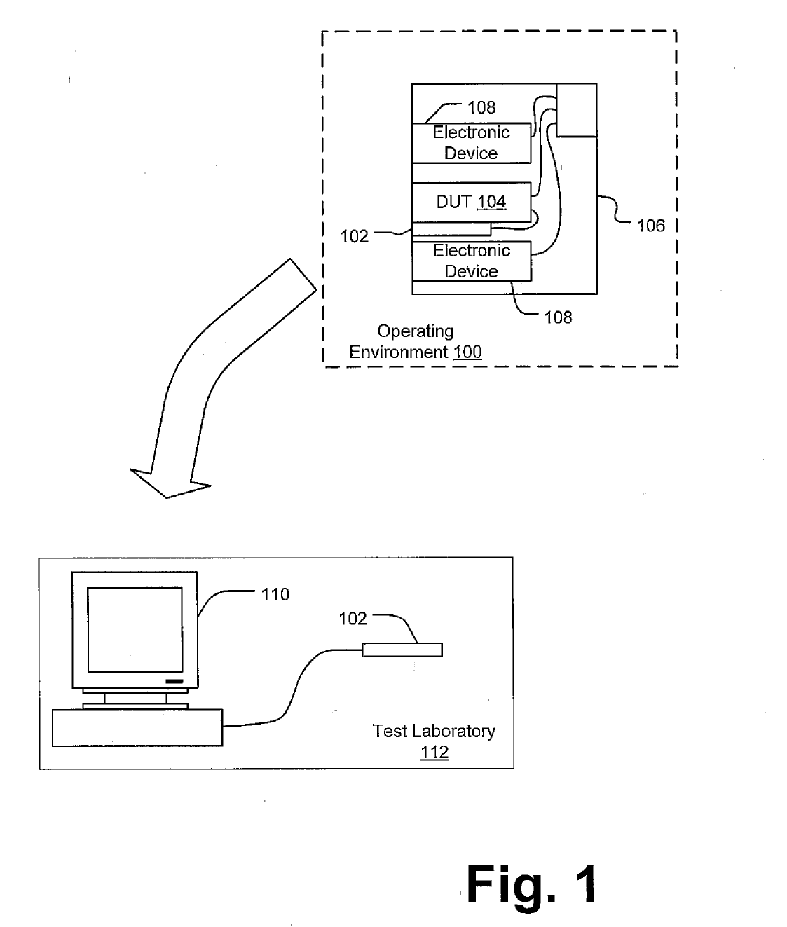

FIG. 1 shows a schematic representation of a trace device 102 used to monitor a device under test (DUT) 104 in situ in its operating environment 100. The operating environment 100, for example, may comprise any environment within which the DUT 104 is normally operated. In one particular implementation, for example, the operating environment 100 comprises the environment the DUT 104 was operating in when the DUT 104 experienced an error or other failure leading to a debugging operation.

The trace device 102 monitors trace data, which may include, for example, code trace signals from the DUT 104 as well as other stimuli, signals, inputs, outputs, and/or triggers affecting the DUT 104. Results of the monitoring may be used, for example, to debug the operation of the DUT 104 as the code executes on the DUT 104 and/or as the DUT 104 undergoes external stimuli (e.g., temperature, movement, or the like) from the actual operating environment in which the error occurred. In one particular implementation, for example, the DUT 104 may comprise an electronic device housed in a rack 106 with other electronic devices 108. A rack 106 of disk drives, for example, may include a trace device 102 that monitors one or more operation of the DUT 104 in situ within the rack 106. As such, the trace device 102 monitors the operation of the DUT 104 in its normal operating environment 100 instead of at a remote location (e.g., a test laboratory) or in a different configuration (e.g., outside of the rack).

The DUT 104, for example, may comprise a data storage device (e.g., a magnetic disk drive, an optical disk drive, a server, a tape drive, or any other type of data storage device), a computing device (e.g., a personal computer, a motherboard, or other computing device), or any other electronic equipment including a processor that generates trace data. The DUT 104 may be operating in any type of operating environment 100, for example, may comprise a data storage environment (e.g., an array of disk drives, an array of servers, or an array of other data storage devices), a network environment, a personal computer (e.g., running an operating system), or any other environment in which electronic equipment including a processor and executing code may normally operate. In many implementations, for example, the DUT 104 is housed or located within a rack, housing, or other closely fitting configurations. A disk drive DUT, for example, may be located within a rack of disk drives or a server DUT may comprise a “blade” server located within a frame or other housing. Often, these electronic devices are located closely together to minimize the form factor of the overall rack or housing but include small openings designed to allow air to flow between the devices to cool them.

In one exemplary implementation, the trace device 102 complies with a form factor of the DUT 104 in one, two, or three dimensions so that the trace device 102 can fit in situ within a rack or housing including the DUT 104 and other electronic devices 108 without significantly affecting the operating environment of the DUT 104. In some implementations, the trace device 102 is also small enough (e.g., thin enough) to fit between the DUT 104 and another electronic device 108. The trace device 102 may be mounted to the DUT 104 (e.g., in a piggyback fashion) or may be mounted or otherwise supported in situ within the rack 106 or housing (e.g., resting on top of another electronic device 108).

The trace device 102 is coupled to the DUT 104 via a communication link 110. The communication link 110, for example, may comprise a connector coupled to a debug port of the DUT 104 or to another specialized port that provides trace data from the DUT 104. The communication link 110 may comprise any type of wired link (e.g., a serial, universal serial bus, parallel or other standardized or specialized wired communication link) or wireless link (e.g., radio frequency, 802.11 wireless link, CDMA, Bluetooth, or other standardized or specialized wireless communication link). The trace device 102 receives trace data, such as code trace signals, other stimuli, inputs, outputs, and/or external triggers from the DUT 104 (and/or other sources) via the communication link 110. The trace device 102 may also include environmental sensors, such as temperature, shock, movement, humidity, electrostatic discharge (ESD), etc. The trace device 102 loads the trace data into a memory or buffer (e.g., a circular first in, first out (FIFO) buffer, a volatile random access memory (RAM) or other memory module) and monitors the trace data received from the DUT 104 for a trigger identifying a condition for which the trace device 102 is seeking.

Upon detection of a trigger, the trace device 102 stores trace data in nonvolatile memory and provides an indication that its operation is complete. The trace device 102 may then be removed from the DUT 104 and connected to another computer (e.g., in a remote laboratory of a manufacturer) to download and analyze the captured trace date (and possibly other stimuli, inputs, outputs, and/or external triggers) for debugging.

In example implementations, the DUT 104 may further comprise other communication link(s) for receiving external triggers from sources other than the DUT 104, for initial programming of the trace device, for communicating with another computing device (e.g., for dumping trace data after it has been received), for debugging the operation of the trace board (e.g., for connecting to a separate bench logic analyzer), and for other communications.

Once the trace device 102 has finished monitoring the operation of the DUT 104, the trace device 102 may be connected to another computing device 110 via a communication link 114 for analyzing the operation of the DUT 104 from trace data stored on the trace device 102. The trace device 102, for example, may be removed from the operating environment 100 of the DUT 104 and connected to the other computing device 112 for analyzing the trace data collected by the trace device 102. The computing device 112, for example, may be located remotely from the DUT 104 (e.g., at a manufacturer's laboratory) or locally to the operating environment 100 of the DUT 104.

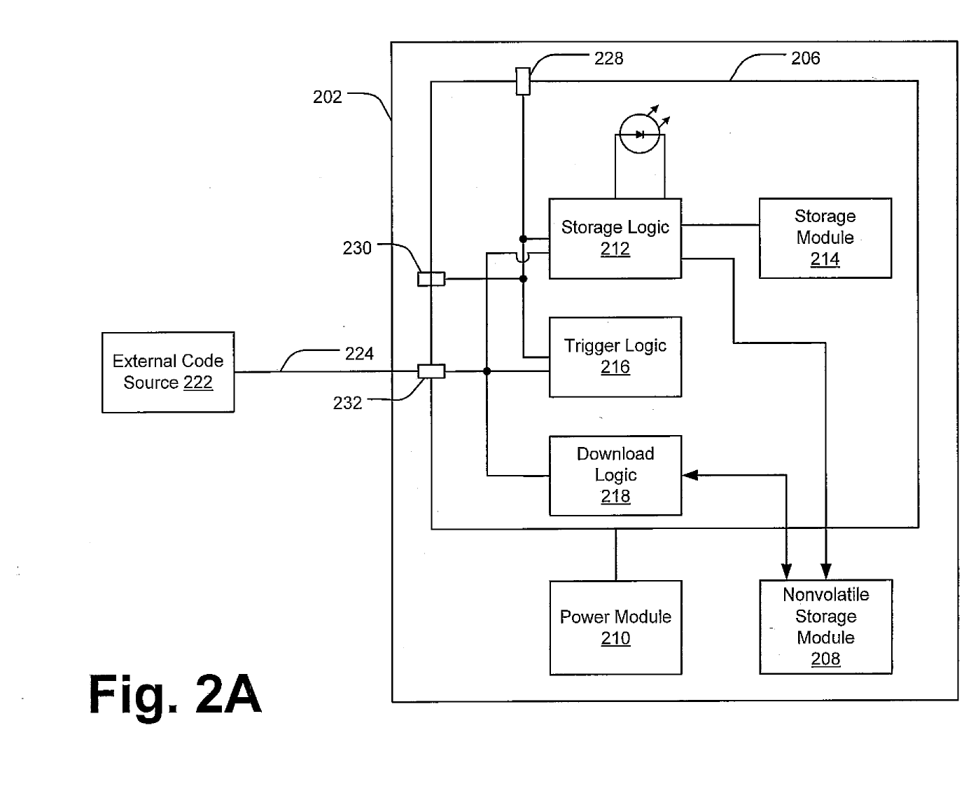

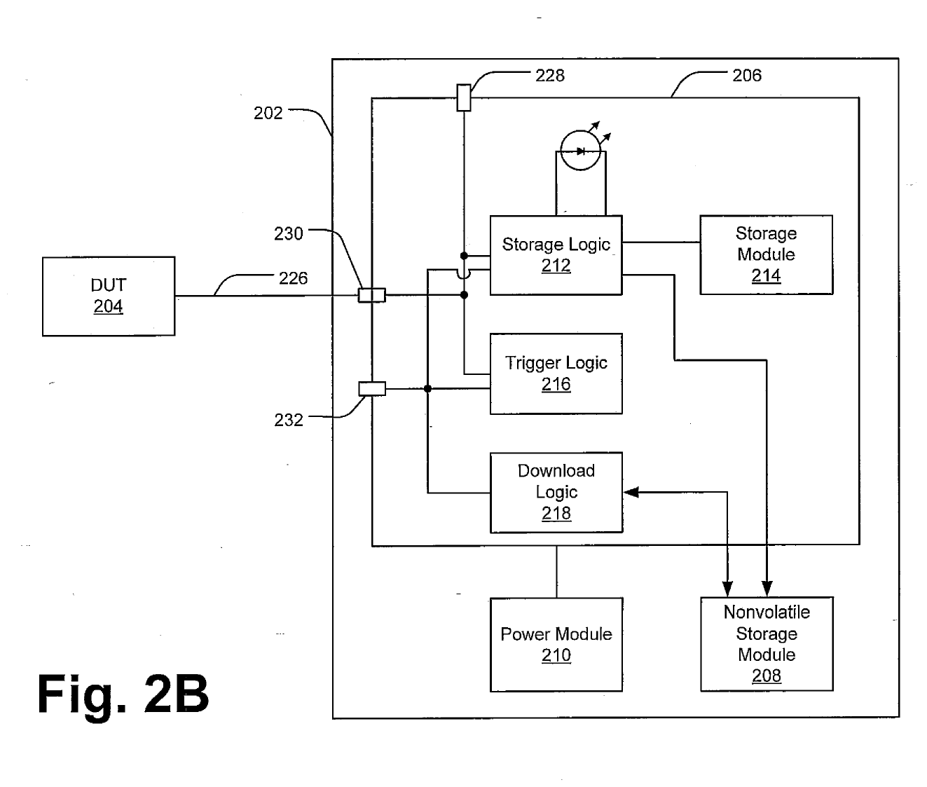

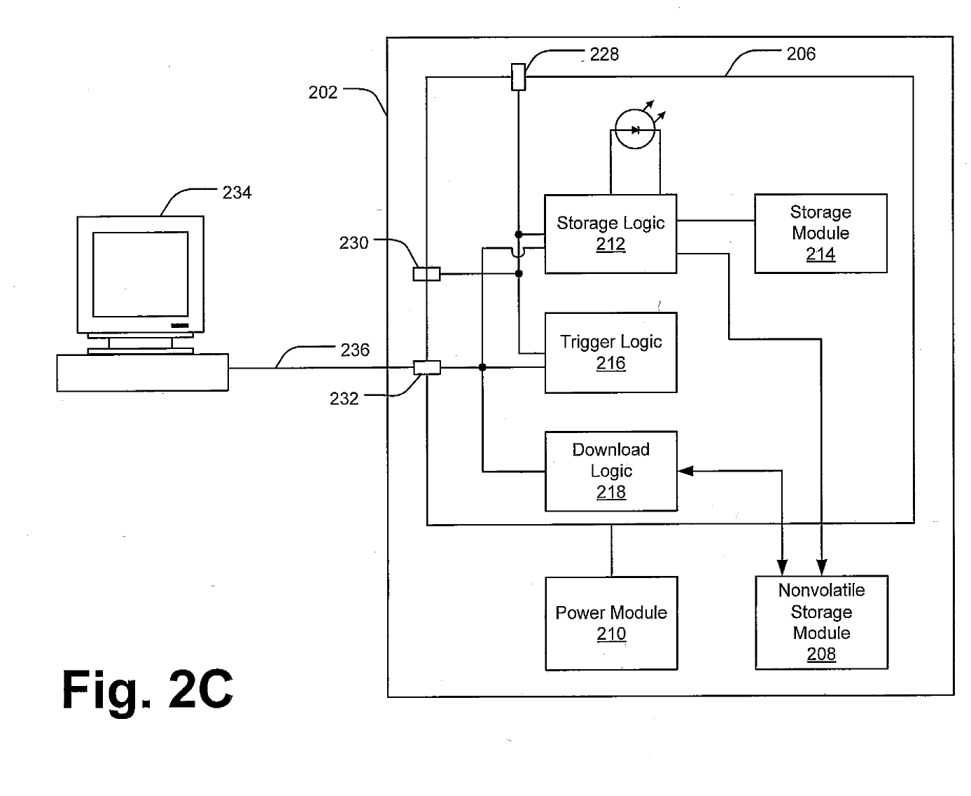

FIGS. 2A-2C show exemplary representations of a trace device 202 in various configurations. In FIG. 2A, for example, a communication interface 232 of the trace device 202 is shown connected to an external code source 222 via a communication link 224. The communication interface 232, for example, may comprise any wired communication interface (e.g., a port) or any wireless communication interface (e.g., an antenna). The external code source 222 provides operational code to the trace device 202 for use in monitoring a DUT. Operational code provided to the trace device 222 may, for example, comprise code to be executed by the trace device 222, data (e.g., one or more triggers to be detected), or any other code that is useful in determining the operation of the trace device 202. In one particular implementation, for example, the operational code may comprise firmware (e.g., code embedded in the trace device) executed by a microprocessor of the trace device 202. In another implementation, the operational code may comprise executable code externally accessible and/or editable by the external code source 222 or a DUT being tested by the test device 202.

As shown in FIG. 2A, the monitor module 206 receives operational code from the external code source 222 (e.g., a personal computer (PC)) operatively connected to the trace device 202 via the communication link 224 (e.g., a serial, universal serial bus, parallel, RF, Bluetooth, 802.11, or other wired or wireless communication link) and the communication interface 232.

The external code source 222 may comprise any device that can provide operational code to the trace device 202. The external code source 222, for example, may comprise a PC, server, PDA, other computing device, or even a DUT that is to be monitored by the trace device 202. In one exemplary implementation, for example, the external code source 222 comprises a DUT to be monitored. In this implementation, the DUT may provide certain triggers that are specific to the operation of the particular type of DUT.

The trace device 202 comprises a monitor module 206, a nonvolatile storage module 208, and a power module 210. The monitor module 206, for example, may comprise a field programmable gate array with a programmable memory (e.g., a Flash read only memory (ROM)) or a single integrated circuit, such as an application specific integrated circuit (ASIC). Other implementations, such as using discrete components on a PC board, are also possible, however.

In this exemplary implementation, the monitor module 206 comprises a storage logic 212, a storage module 214, a trigger logic 216, a download logic 218, and an indicator 220. The monitor module 206 and the nonvolatile storage module 208 receive power from the power module 210. The power module 210, for example, may receive power from a DUT, an external code source, or an external power connector (e.g., where one or more communication link does not provide power to the trace device 202). Although the modules 206, 208, and 210 are shown as separate modules, the modules may be implemented in any combination of integrations.

The operational code, for example, may be downloaded under the control of the download logic 218 during manufacture or set-up remote from the operating environment of a DUT to be monitored. The operational code may also be loaded or edited locally at the operational environment of the DUT to be monitored (e.g., to identify one or more particular trigger to be identified). The operational code, for example, may be received from the DUT to be monitored itself or from another external code source. The operational code is downloaded from the external code source 222, whether a DUT to be monitored or another external code source, the download may be performed under the control of the download logic 218 and/or the external code source 222 (e.g., the DUT to be monitored or the other external code source). The operational code received from the external code source 222 may comprise code for the storage logic 212, the trigger logic 214, and/or the download logic 216.

As shown in FIG. 2B, the monitor module 206 is also able to be coupled to a DUT 204 that is to be monitored via a second communication link 226 and a communication interface 230 (although the communication link 224 and/or the communication interface 232 shown in FIG. 2A may alternatively be used). In the implementation shown in FIG. 2B, the monitor module 206 receives trace data from the DUT 204 via the communication link 226 and the communication interface 230. The trace data, for example, may comprise code trace signals, other stimuli, inputs, outputs, and/or external triggers affecting the operation of the DUT 204.

The monitor module 206 may also comprise a pass-through interface 228 (e.g., a wired communication interface, such as a port, or a wireless communication interface, such as an antenna). A logic analyzer, for example, may be connected to the pass-through interface 228 to allow for simultaneous tracing of the DUT through the trace device 202. Similarly, the pass-through port may allow multiple trace devices to be connected together (e.g., daisy-chained) via the pass-through port to monitor (e.g., simultaneously or serially) for different trigger events. The connected trace devices may also have their operational code provided and/or edited (e.g., by a DUT or external code source) via the pass-through ports.

The storage logic 212 receives the trace data and other inputs and stores the data in the storage module 214. The storage module 214, for example, may comprise a buffer (e.g., a circular FIFO buffer), volatile memory (e.g., RAM) or non-volatile memory (e.g., the data could be cached or paged to increase speed). The storage logic 212 thus controls the storage module 214 to store the trace data and other inputs received.

The trigger logic 216 is used to detect a trigger and direct the storage logic 212 to transfer at least a portion of the trace data to the nonvolatile storage module 208. The trigger logic 216 may, for example, receive a trigger from the DUT 204, another electronic device, or sensor and/or monitor the trace data for a predetermined trigger. A trigger, for example, may comprise an indication of a failure of the DUT 204 or some other suspected event related to debugging the operation of the DUT 204. When the trigger logic 216 detects the trigger (from whatever source), the trigger logic 216 directs the storage logic 212 to transfer at least a portion of the trace data stored in the storage module 214 to the nonvolatile storage module 208. (If the storage module 214 is nonvolatile storage, however, the trigger logic 216 may alternatively direct the storage logic 212 to stop transferring new trace data to the storage module 214 after the trigger is detected instead of transferring the trace data out of the storage module 214 into another nonvolatile storage module 208.)

In one particular implementation, for example, the trace device 202 may capture trace data within a time “window” in response to detecting a trigger. The trace device 202, for example, may store trace data corresponding to a window of time beginning with the detection of the trigger, ending with the detection of the trigger, or including the time in which the trigger is detected. In one exemplary implementation, for example, the trace device 202 may capture trace data for a predetermined period of time before and/or after the detection of the trigger (although the time periods before and after the trigger need not be the same). This trace data may be transferred to the nonvolatile storage module 208 for later retrieval.

After the trace data has been transferred to the nonvolatile storage module 208, the indicator 220 may be activated to indicate to a user that the process is complete. The indicator 220 may be controlled, for example, by the trigger logic 216 and/or the storage logic 212 to indicate that the process is complete. The indicator 220 may comprise any type of indicator, such as one or more LEDs, other visual indicators, or an audible (e.g., a speaker or buzzer) or other sensory indicator. The trace device 202 can then be disconnected from the DUT 204 and removed from the operating environment.

FIG. 2C shows another exemplary representation of a trace device 202 connected to an external analysis device 234 via a communication link 236 and the communication interface 232. Again, the trace device 202 may alternatively use another communication link and/or communication interface, such as the communication links 226, 228 and/or the communication interface 230 shown in FIGS. 2A and 2B, respectively, or any other communication link or interface. The trace data stored in the nonvolatile storage module 208 can be downloaded from the trace device 202 (e.g., under the control of the download logic 218 and/or the external analysis device 234) to the external analysis device 234 for display and/or analysis. The external analysis device 234, for example, may comprise a personal computer or other computing device, such as a logic analyzer. Alternatively, the external analysis device 234 may merely comprise a display device (e.g., a monitor or printer) that displays the trace data stored in the nonvolatile storage module 208.

In one exemplary implementation, the monitor module 206 of the trace device 202 includes an uncommitted FPGA. The FPGA includes a random access memory (RAM) including a circular FIFO buffer (e.g., a buffer comprising 32 K samples of 21 bits apiece) that functions as the data storage module 214 to store trace data as described above. In one possible implementation, the RAM may also comprise a memory space for storing executable code providing the functionality of the storage logic 212, the trigger logic 216, and the download logic 218 (although this executable code may also be stored elsewhere). The FPGA receives inputs from the DUT 204 (e.g., a debug port of an integrated circuit of an electronic device) as well as general purpose inputs and outputs, sensors (e.g., environmental sensors). The FPGA may pull or poll data from the inputs. The FPGA further includes a UART for providing serial data communication to download the trace data stored in the nonvolatile data storage module (although any other communication protocol could also be used). A translator chip is also provided for translating the logic signal levels to RS232 levels for the serial communication. A Flash programmable ROM is provided as the nonvolatile data storage module. Finally, LED lamps are used as the indicator.

In one particular implementation, for example, the trace device 202 may comprise several LED lamps to allow for a visual communication of operational status to an operator. A green LED lamp, for example, may be illuminated to indicate that the trace device 202 is powered on and ready to begin monitoring trace data. A red LED lamp may be steadily illuminated to indicate that the trace device is currently monitoring trace data and waiting for a trigger or other event. A red LED may also be flashed to indicate that the desired trigger or event has occurred and that the trace device 202 is ready for the trace data to be downloaded and/or to be connected to a logic analyzer. Other LED lamps or signals may be used as an activity indicator or for a no-touch/at distance communication channel to a monitoring system or to an operator using a wireless handheld device (e.g., a PDA).

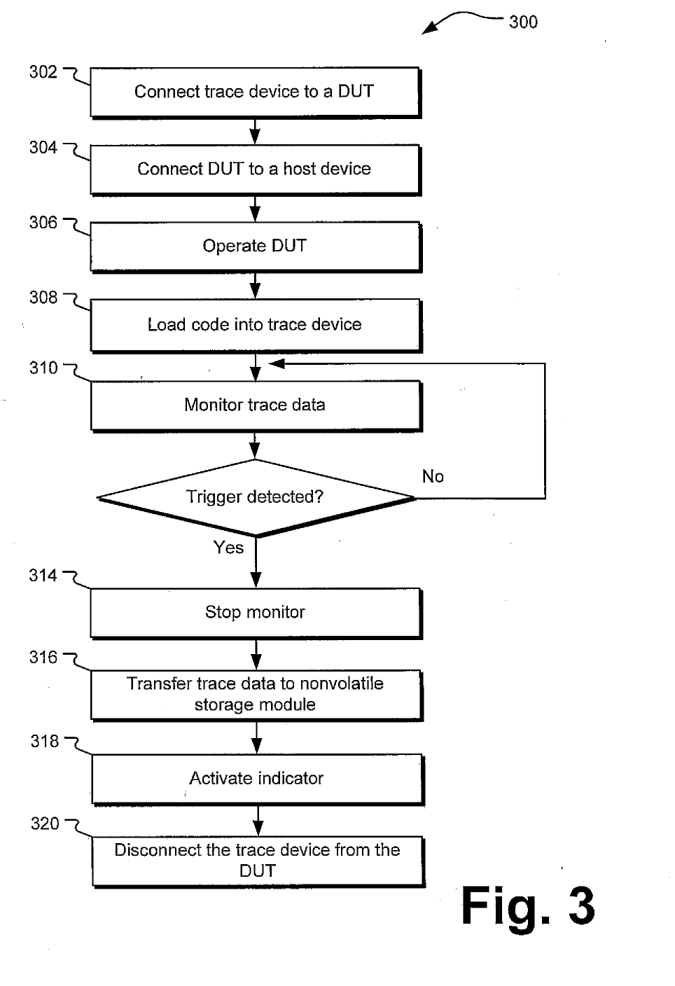

FIG. 3 shows exemplary operations 300 for setting up a test of a DUT in its operating environment. In connecting operation 302, the trace device is connected to the DUT. The trace device may be connected to the DUT via any type of communication link. In one implementation, for example, a form-factor connector is used to connect the trace device to a debug port of the DUT. The DUT is then connected to a host (e.g., a server, network node, or PC) for operation in connecting operation 304. The DUT is then operated in operating operation 306. The operation of the DUT, for example, may include powering up the DUT and operating the device in a standard or debugging mode in order to facilitate the monitoring of the DUT by the trace device.

Code is then loaded into the trace device (e.g., a logic analyzer module of the trace device) in loading operation 308. In one implementation, for example, the code is loaded into the trace device directly from the DUT. The code may be loaded from another device and/or may be preloaded onto the trace device before it is connected to the DUT. The code allows the trace device to be programmed to perform any number of functions. By being programmed (in situ or remotely), the trace device can passively trace, actively monitor, and/or control the DUT. These features allow for reusable trace devices and/or for faster and more efficient monitoring by being able to be programmed on the fly (e.g., as different aspects of a failure are discovered in the debug process). In addition, when used to monitor a number of DUTs, the trace device may be able to be reprogrammed by one or more of the DUTs or by another detached device to allow for individualized monitoring. The code loaded into the trace device, for example, may comprise one or more triggers or events that the trace device is to look for during operation of the DUT, identify one or more particular ports of the DUT to monitor, how to store the data, how much data to store, and what type of data to store. Alternatively, the triggers or events may be pre-loaded into the trace device to be used during the operation of the DUT.

The trace device then monitors trace data (e.g., code trace signals, other stimuli, inputs, outputs (e.g., general purpose I/Os), and/or external triggers affecting the operation of the DUT) in monitoring operation 310. As the trace device is monitoring the trace data, the trace device checks to determine whether a predetermined trigger has been detected in decision operation 312. If the trigger has not yet been detected, the trace device continues to monitor the trace data in monitoring operation 3 10. When the trigger is detected, however, the decision operation 312 branches to the stop monitor operation 314.

After the trace device stops monitoring the trace data in stop monitor operation 314, the trace device transfers the trace data stored in a volatile storage module to a nonvolatile storage module in transferring operation 316. Once the trace data has been successfully transferred to the nonvolatile storage module, the trace device activates an indicator (e.g., an LED visual indicator) in indicating operation 318. The indicator signals to an operator that the monitoring operation has been completed, the data collected has been stored in nonvolatile storage for later retrieval and analysis, and that the trace device can be disconnected from the DUT in disconnecting operation 320. The trace data may be retrieved by the operator in the operating environment and/or the trace device may be transported to a remote site where the trace data may be downloaded and analyzed.

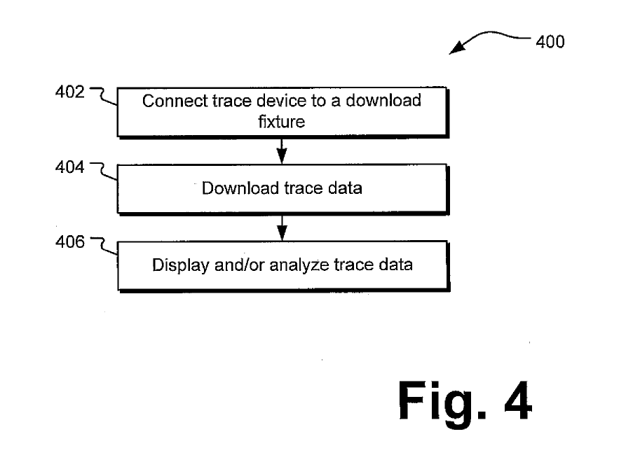

FIG. 4 shows exemplary operations 400 for downloading trace data stored on the trace device for analysis. After the trace device has been removed from a DUT, the trace device is connected to a download fixture (e.g., a PC) via a communication link in connection operation 402. In one implementation, for example, the trace device and the download fixture are connected via a serial link from pins on the trace device to pins on the download fixture although any other type of communication link is also possible. The trace device then downloads the trace data stored in a nonvolatile storage module to the download fixture in downloading operation 404. The downloading operation may be performed under the control of a download logic on the trace device, a download logic on the download fixture, or a combination of each. The trace data is then displayed and/or analyzed on the download fixture (or another device) in display operation 406. The analysis of the trace data, for example, may comprise any type of debugging operation to determine the cause of a fault or other problem associated with the operation of the DUT.

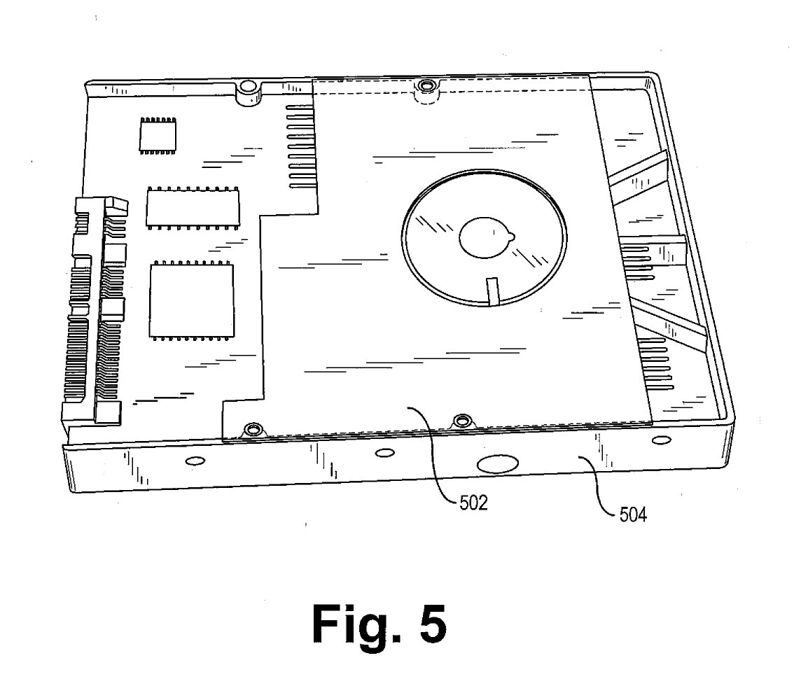

FIG. 5 shows an exemplary implementation of a trace device 502 in form factor with a DUT 504. In the implementation shown in FIG. 5, for example, the DUT 504 comprises a disk drive. The trace device complies with the form factor of the disk drive in at least two dimensions. In one possible implementation, the trace device may also comply with the form factor of the disk drive (or other DUT) in three dimensions (e.g., where the trace device fits within a housing of the disk drive (or other DUT)).

Certain implementations of the present invention have been discussed with reference to a disk drive other data storage device. One skilled in the art will recognize that the present invention may also be applied to any electronic device including a processor executing code, such as a magnetic disk drive, an optical disc drive, a magneto-optical disc drive, a compact disc drive, a server, a personal computer, office equipment such as copiers and fax machines, or other electronic devices including a processor executing code.

The technology described herein is implemented as logical operations and/or modules in one or more systems. The logical operations may be implemented as a sequence of processor-implemented steps executing in one or more computer systems and as interconnected machine or circuit modules within one or more computer systems. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

The above specification, examples and data provide a complete description of the structure and use of example embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

Although the subject matter has been described in language specific to structural features and/or methodological arts, it is to be understood that the subject matter defined in the appended claims is not necessarily limited to the specific features or acts described above. Rather, the specific features and acts described above are disclosed as example forms of implementing the claimed subject matter.

What is claimed is:

1. An apparatus comprising:
a trace data capture fixture removably connected in situ to a device under test in an operating environment of the device under test, the fixture comprising a trace data storage module for storing trace data received from the device under test during operation.

2. The apparatus of claim 1 wherein the trace data capture fixture complies with a form factor of the device under test in at least two dimensions.

3. The apparatus of claim 1 wherein the trace data capture fixture comprises a trigger logic module that detects a trigger and directs the trace data stored in the trace data storage module to be transferred to a nonvolatile data storage module.

4. The apparatus of claim 3 wherein the trigger logic module directs a time window of trace data to be transferred to the nonvolatile data storage module in response to the detection of the trigger.

5. The apparatus of claim 1 wherein the trace data capture fixture comprises a trigger logic module that detects a trigger and directs the trace data storage module to stop storing the trace data.

6. The apparatus of claim 1 wherein the trace data storage module comprises a volatile data storage module.

7. The apparatus of claim 1 wherein the trace data capture fixture comprises a data storage logic module that stores the trace data in the trace data storage module.

8. The apparatus of claim 7 wherein the data storage logic module further transfers the trace data from the trace data storage module to a nonvolatile trace data storage module.

9. The apparatus of claim 8 wherein the data storage logic transfers the trace data from the trace data storage module to a nonvolatile trace data storage module under direction of a trigger module when the trigger module detects a trigger.

10. The apparatus of claim 9 wherein the trace data capture fixture comprises an indicator that provides an indication when the trace data has been transferred from the trace data storage module to the nonvolatile trace data storage module.

11. The apparatus of claim 1 wherein the trace data capture fixture is removably connected to a debug port of the device under test.

12. The apparatus of claim 1 wherein the device under test comprises a disk drive.

13. An apparatus comprising:
a trace data capture fixture removably connected to a device under test, the trace data capture fixture comprising a trace data storage logic for transferring the trace data from a volatile trace data storage module to a nonvolatile data storage module in response to a detection of a trigger.

14. The apparatus of claim 13 wherein the trace data capture fixture comprises a trigger logic module that detects the trigger and directs the trace data storage module to transfer the trace data from the volatile trace data storage module to the nonvolatile data storage module in response to the detection of the trigger.

15. The apparatus of claim 13 wherein the trace data storage logic stores trace data in a volatile trace data storage module during an operation of the device under test.

16. A method comprising:
removably connecting a trace device to a device under test in situ in an operating environment of the device under test;
operating the device under test;
receiving trace data from the device under test; and
storing the trace data in a trace data storage module.

17. The method of claim 16 further comprising transferring the trace data from the trace data storage module to a nonvolatile trace data storage module in response to detecting a trigger.

18. The method of claim 16 wherein the removably connecting operation comprises removably connecting the trace device to a debug port of the device under test.

19. The method of claim 16 further comprising disconnecting the trace device from the device under test.

20. The method of claim 19 further comprising removing the trace device from the operating environment of the device under test.
